(19) United States
(12) Patent Application Publication
(10) Pub. No.: US 2026/0358686 A1
(43) Pub. Date: Nov. 12, 2026

(54) HANDHELD SHOOTING MECHANISM

(71) Applicant: TILTA INC., Burbank, CA (US)

(72) Inventors: Long MA, Shenzhen (CN); Wenping ZENG, Shenzhen (CN); Kefeng ZHOU, Shenzhen (CN)

(21) Appl. No.: 19/670,961

(22) Filed: May 7, 2026

(30) Foreign Application Priority Data
May 12, 2025 (CN) 202520929508.3

(51) Int. Cl. G03B 17/56; F16M 13/02; F16M 13/04

(52) U.S. Cl. CPC G03B 17/561; F16M 13/02; F16M 13/04; G03B 17/563

(57) ABSTRACT

Provided herein is a handheld shooting mechanism, including a handheld assembly and a mounting assembly; the handheld assembly includes a connecting portion and handles provided at both ends of the connecting portion; the mounting assembly is used for mounting a drone, and the mounting assembly is mounted on the connecting portion.

### CROSS-REFERENCE TO RELATED APPLICATIONS

The present application for patent claims priority to and the benefit of pending Chinese Application No. 202520929508.3, filed May 12, 2025, and hereby expressly incorporated by reference herein as if fully set forth below in its entirety and for all applicable purposes.

### TECHNICAL FIELD

The present disclosure relates to the technical field of shooting equipment, and specifically to a handheld shooting mechanism.

### INTRODUCTION

Drone photography is a new form of photography. It breaks through the perspective limitations of traditional ground-based photography, enabling multi-angle and omnidirectional shooting from various dimensions such as high altitude, low altitude, high speed, and hovering, presenting grand and spectacular panoramic images from a unique perspective. Therefore, it has gradually become one of the commonly used tools for outdoor shooting. Typically, the usage mode of a drone involves a user operating the drone to fly at low altitude via a remote control handle for shooting. The usage mode is relatively singular.

### BRIEF SUMMARY

Provided herein is a handheld shooting mechanism capable of mounting a drone onto the shooting mechanism to enable handheld gimbal movement shooting with the drone, thereby providing a new shooting mode and meeting diverse shooting needs of users.

Some aspects of the present disclosure provide: a handheld assembly, including a connecting portion and handles provided at both ends of the connecting portion; and a mounting assembly, used for mounting a drone, wherein the mounting assembly is mounted on the connecting portion.

With this arrangement, during use, a user can mount the drone on the mounting assembly, that is the mounting assembly can be carried on the connecting portion. Then the user can hold the handles at both ends of the connecting portion to perform gimbal movement. Thus, the drone can be utilized in a handheld gimbal movement mode, thereby enriching the usage modes of the drone and diversifying the user's operation thereof.

### BRIEF DESCRIPTION OF THE DRAWINGS

FIG. 1 is a schematic drawing illustrating a handheld shooting mechanism according to some aspects of the disclosure.

FIG. 2 is a schematic drawing illustrating the handheld shooting mechanism according to some aspects of the disclosure.

FIG. 3 is a schematic drawing illustrating a mounting member according to some aspects of the disclosure.

FIG. 4 is a schematic drawing illustrating a mounting cage according to some aspects of the disclosure.

FIG. 5 is a schematic drawing illustrating a handheld assembly according to some aspects of the disclosure.

### LIST OF REFERENCE NUMERALS

10. Handheld shooting mechanism;

1. Handheld assembly;
11. Connecting portion;
12. Handle;
13. External expansion mount;

2. Mounting assembly;
21. Mounting member;
211. First sliding groove;
212. Second sliding groove;
2121. Opening;
2122. Limiting port;
213. First side surface;
214. First hole channel;
2141. First through hole;
2142. First stopper wall;
215. Second hole channel;
2151. Second through hole;
2152. Second stopper wall;
216. Third hole channel;

22. Mounting cage;
221. Second slider;
2211. Limiting recess;
2212. Limiting block;
222. First cage body;
2221. Cutout;
223. Second cage body;
224. First locking member;
2241. First mounting shaft;
2242. Second mounting shaft;
2243. Knob;
2344. Captive screw;
225. Mounting space;
226. Buckle body;
227. Quick release plate;

23. Limiting member;
231. Limiting shaft;
2311. Limiting protrusion;
2312. First shaft body;
2313. Second shaft body;
2314. Limiting inclined surface;
232. Elastic member;
233. Button;

3. Grip assembly;
31. Grip; 3
11. First slider; 3
12. Expansion interface;
32. First fastener;

4. Mounting base;
41. Second fastener.

### DETAILED DESCRIPTION

Currently, users typically employ drones for outdoor low-altitude panoramic photography, controlling the drone's propellers to fly via a remote control handle to capture images. In this type of shooting, the user operates a joystick on the drone remote control handle, and the drone responds to the joystick signal to execute flight maneuvers for shooting, thereby enabling panoramic photography from unique perspectives. Provided herein is a handheld shooting mechanism 10, which is capable of carrying a drone and being manually held for gimbal movement shooting. Users can utilize the handheld shooting mechanism 10 with the drone mounted thereon for handheld gimbal movement shooting as desired, thereby offering users a new mode of drone operation and achieving dual-purpose functionality from a single device.

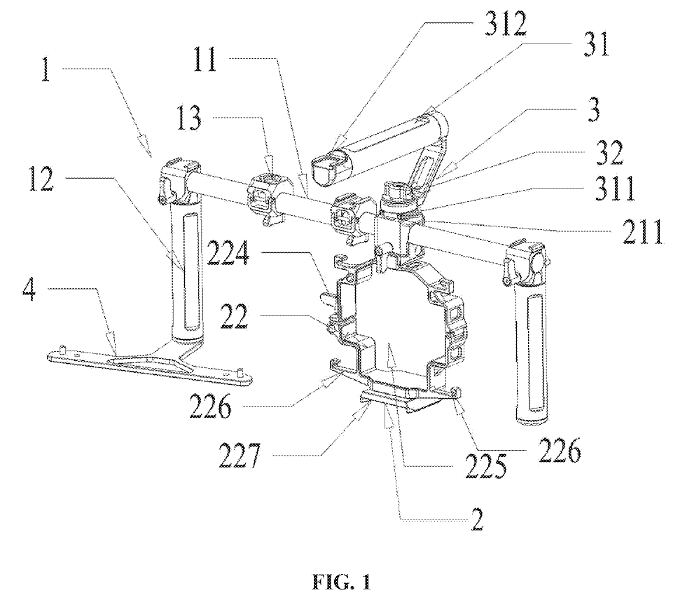

Referring to FIG. 1, the handheld shooting mechanism 10 includes a handheld assembly 1 and a mounting assembly 2. The handheld assembly 1 includes a connecting portion 11 and handles 12 provided at both ends of the connecting portion 11. The mounting assembly 2 is configured for mounting a drone, and the mounting assembly 2 can be mounted on the connecting portion 11.

With this arrangement, during use, a user can mount the drone on the mounting assembly 2, for example, the mounting assembly 2 can be carried on the connecting portion 11. Then the user can hold the handles 12 at both ends of the connecting portion 11 to perform gimbal movement. Thus, the drone can be utilized in a handheld gimbal movement mode, thereby enriching the usage modes of the drone and diversifying the user's operation thereof.

In some aspects, during certain relatively high-angle handheld gimbal movement shots, the user can hold the handles 12 aloft with relative ease. During certain relatively low-angle handheld gimbal movement shots, the user might need to squat while holding the handles 12 aloft for shooting, which is comparatively inconvenient. Referring to FIG. 1, the handheld shooting mechanism 10 herein can include a grip assembly 3, which is connected to the top of the mounting assembly 2 or the connecting portion 11 so as to be positioned above the connecting portion 11. With this arrangement, the user can hold the grip assembly 3 to perform handheld gimbal movement, thereby facilitating shooting at low angles with greater convenience.

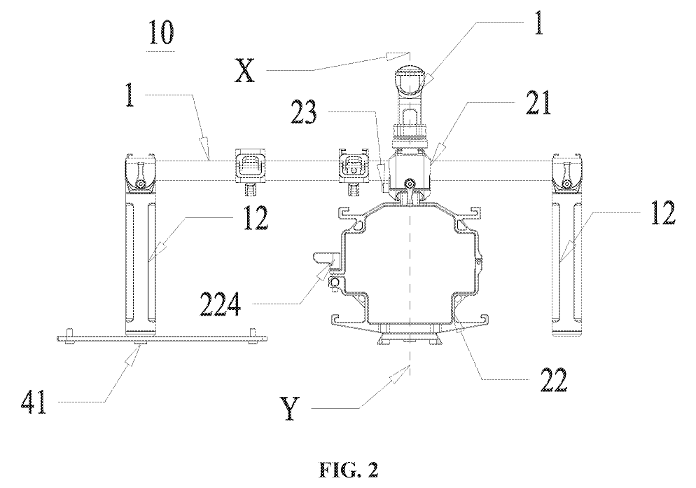

In some aspects, the grip assembly 3 is mounted on the top of the mounting assembly 2, with the mounting assembly 2 located below the connecting portion 11 and the grip assembly 3 located above the connecting portion 11. The center line of the grip assembly 3 can coincide with the center line of the mounting assembly 2. More specifically, referring to FIG. 2, the coincidence of the center line of the grip assembly 3 and the center line of the mounting assembly 2 means that lines X and Y in the figure can substantially overlap when extended. With this arrangement, the force distribution on the camera is substantially uniform when the user uses the grip assembly 3, thereby yielding a relatively stable shooting perspective, which is important for shooting efficiency.

Regarding the connection method between the grip assembly 3 and the mounting assembly 2, referring to FIG. 1, the grip assembly 3 includes a grip 31 and a first fastener 32. One of the bottom of the grip 31 and the top of the mounting assembly 2 is provided with a first slider 311, and the other is provided with a first sliding groove 211. The first slider 311 is disposed in the first sliding groove 211, and the first fastener 32 passes through the bottom of the grip 31 and is threadedly connected to the mounting assembly 2. In one example, the bottom of the grip 31 includes the first slider 311, and the top of the mounting assembly 2 includes the first sliding groove 211. The first fastener 32 can pass through the bottom of the grip 31 and be threadedly connected to the top of the mounting assembly 2. Here, sliding the first slider 311 into the first sliding groove 211 enables preliminary installation of the grip 31 on top of the mounting assembly 2. Further, by rotating the first fastener 32 to threadedly connect the first fastener 32 to the mounting assembly 2, the grip 31 and the mounting assembly 2 are further pressed, thereby stably securing the first slider 311 within the first sliding groove 211 and achieving a dual secure installation. Since the user is generally in a moving state during operation, a stable mounting mechanism is crucial for the gimbal movement shooting process.

In some aspects, referring to FIG. 1, one or more expansion interfaces 312 can be provided on the grip 31 for attaching external accessories, which can include, for example, a cold shoe mount, an ARRI locating hole, etc.

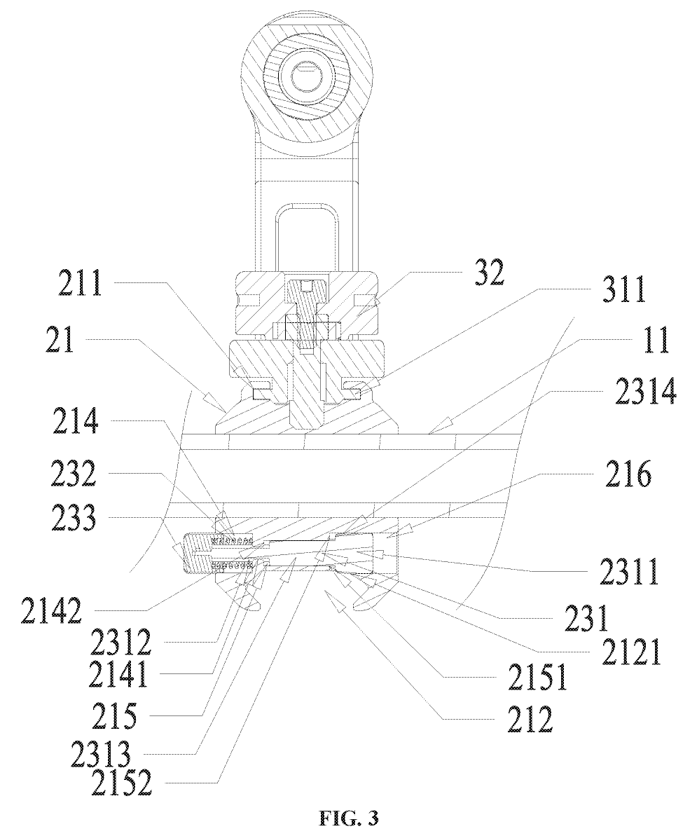

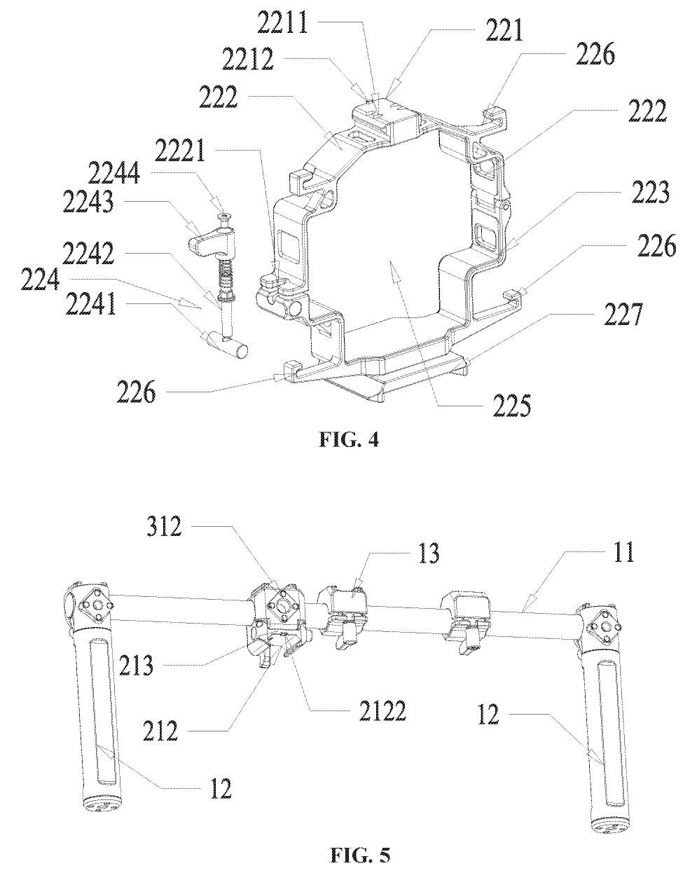

Referring to FIGS. 2 and 3, the mounting assembly 2 includes a mounting member 21 and a mounting cage 22. The mounting member 21 is mounted on the connecting portion 11. The mounting cage 22 is mounted around the outer periphery of the drone, and the mounting cage 22 is mounted on the mounting member 21. With this arrangement, the user can snap the drone into the mounting cage 22. For example, the mounting cage 22 is located below the connecting portion 11. The mounting cage 22 is provided with a second slider 221. A side of the second slider 221 facing the mounting member 21 is provided with at least one limiting recess 2211. The mounting member 21 is provided with a second sliding groove 212 and is elastically provided with a limiting member 23. A side of the second sliding groove 212 facing the slider is provided with an opening 2121 to expose the limiting member 23. When the second slider 221 is installed in the second sliding groove 212, the limiting member 23 can protrude from the opening 2121 and be retained in the limiting recess 2211. With this arrangement, after installation, the limiting member 23 can protrude from the opening 2121 and be retained in the limiting recess 2211, thereby tightly clamping the second slider 221 within the second sliding groove 212. For example, the second slider 221 can be a NATO slider, and the second sliding groove 212 can be a NATO rail. To unlock, the limiting member 23 can be pressed to move toward the interior of the mounting member 21, whereby a portion of the mechanism retracts from the opening 2121, thereby releasing the limitation on the second slider 221. In one aspect, referring to FIG. 4, one end of the second slider 221 can include a limiting block 2212. Referring to FIG. 5, one end of the second sliding groove 212 can include a limiting port 2122, and the limiting block 2212 can be accommodated in the limiting port 2122. Specifically, the mounting member 21 has a first side surface 213, which is recessed in a direction perpendicular to the connecting portion 11 to form the limiting port 2122 with an opening on the first side surface 213. The limiting port 2122 facilitates the sliding entry of the limiting block 2212, and the bottom wall of the limiting port 2122 can prevent excessive sliding of the second slider 221. Multiple expansion interfaces 312 can be provided on the mounting member 21 for attaching external accessories, which can include, for example, a cold shoe mount, an ARRI locating hole, etc.

Referring to FIG. 3, the limiting member 23 includes a limiting shaft 231, an elastic member 232, and a button 233. The button 233 is connected to the limiting shaft 231 and protrudes outside the mounting member 21. The elastic member 232 is sleeved over the limiting shaft 231 and disposed between the button 233 and the mounting member 21. An end of the limiting shaft 231 remote from the button 233 is provided with a limiting protrusion 2311, and the limiting protrusion 2311 has a limiting inclined surface 2314. Referring to FIG. 4, the limiting recess 2211 is arranged obliquely. When the second slider 221 is installed in the second sliding groove 212, the limiting protrusion 2311 can protrude from the opening 2121 so that the limiting inclined surface 2314 abuts against the limiting recess 2211. With this arrangement, the user can press the button 233 to cause the limiting protrusion 2311 to move axially along the limiting shaft 231 and withdraw from the opening 2121, allowing the second slider 221 to slide into the second sliding groove 212. Subsequently, the pressure on the button 233 is released, and under the action of the elastic member 232, the limiting protrusion 2311 resets and is retained within the limiting recess 2211. The limiting protrusion 2311 and the limiting recess 2211 are pressed tightly together via inclined surfaces, further pressing the inclined surface of the second slider 221 tightly against the inclined surface of the second sliding groove 212. For example, referring to FIG. 3, the mounting member 21 includes a first hole channel 214, a second hole channel 215, and a third hole channel 216. A first through hole 2141 is provided between the first hole channel 214 and the second hole channel 215. The size of the first through hole 2141 is smaller than that of the second hole channel 215 to form a first stopper wall 2142. A second through hole 2151 is provided between the second hole channel 215 and the third hole channel 216. The size of the second through hole 2151 is smaller than the cross-sectional size of the third hole channel 216 to form a second stopper wall 2152. The opening 2121 is provided in the third hole channel 216. The limiting shaft 231 includes a first shaft body 2312 and a second shaft body 2313. The first shaft body 2312 is connected to the button 233. One end of the second shaft body 2313 is connected to the first shaft body 2312, and the other end is connected to the limiting protrusion 2311. The cross-sectional size of the first shaft body 2312 is smaller than that of the second shaft body 2313, and the cross-sectional size of the second shaft body 2313 is smaller than that of the limiting protrusion 2311. With this arrangement, during the resetting process of the limiting shaft 231 driven by the button 233, the first stopper wall 2142 and the second stopper wall 2152 can respectively limit the movement of the second shaft body 2313 and the limiting protrusion 2311.

Referring to FIG. 4, the mounting cage 22 includes a first cage body 222, a second cage body 223, and a first locking member 224. The first cage body 222 is connected to the bottom of the mounting member 21. The first end of the first cage body 222 is movably connected to the first end of the second cage body 223, and the second end of the first cage body 222 is detachably connected to the second end of the second cage body 223 via the first locking member 224 to form a mounting space 225 for mounting the drone. With this arrangement, when mounting the drone, the first locking member 224 can be unlocked, the drone can be placed between the second cage body 223 and the first cage body 222, and then the first cage body 222 and the second cage body 223 are locked via the first locking member 224 to clamp the drone securely within the mounting space 225. For example, the first locking member 224 includes a first mounting shaft 2241, a second mounting shaft 2242, and a knob 2243. The first mounting shaft 2241 is provided on the second cage body 223. One end of the second mounting shaft 2242 is connected to and engaged via a hex socket with the knob 2243, and the other end is threadedly connected to the first mounting shaft 2241. The first cage body 222 has a cutout 2221. During installation, the user can pivot the second mounting shaft 2242 to engage the cutout 2221, and then rotate the knob 2243, thereby causing the second mounting shaft 2242 to rotate relative to the first mounting shaft 2241 and pressing the first cage body 222 and the second cage body 223 tightly to clamp the drone. Specifically, the knob 2243 is sleeved over the end of the second mounting shaft 2242 remote from the first mounting shaft 2241, and the end of the second mounting shaft 2242 remote from the first mounting shaft 2241 is connected to a captive screw 2344. A spring is sleeved over the second mounting shaft 2242, with both ends pressing tightly against the knob 2243 and the captive screw 2344.

Considering that the drone has propellers, both sides of the first cage body 222 and the second cage body 223 herein are respectively provided with buckle bodies 226 (e.g., hooked ledges) bent toward the center line of the first cage body 222 and the second cage body 223, configured for limiting and fixing the propellers of the drone. For example, the center line referred to herein is the auxiliary line X shown in FIG. 2.

Further, when the user desires stable shooting footage over an extended period, consideration can be given to placing the drone on auxiliary photographic equipment such as a tripod or a stabilizer. In this regard, a side of the second cage body 223 facing away from the mounting space 225 is connected to a quick release plate 227, configured for mounting the handheld shooting mechanism 10 onto external photographic equipment. The external photographic equipment may be, but is not limited to, a tripod, a stabilizer, etc.

In some aspects, referring to FIGS. 1 and 2, one of the handles 12 is mounted with a mounting base 4, and the mounting base 4 is configured for mounting a drone remote control handle. With this arrangement, it is convenient for the user to operate the rotation of the drone lens and other functions via the drone remote control handle, such as switching between horizontal and vertical shooting angles. As another example, the drone remote control handle features a display screen, which facilitates the user's monitoring of the shooting footage. For example, the mounting base 4 is detachably mounted on the bottom of the handle 12 via a second fastener 41, thereby enabling adjustment of the inclination angle of the mounting base 4 relative to the mounting assembly 2. For instance, as shown in the figure, the mounting base 4 can be arranged in an inclined manner for easier viewing by the user.

In some aspects, the connecting portion 11 includes a connecting tube, on which one or more external expansion mounts 13 are provided. The external expansion mounts 13 include at least one of a cold shoe mount, a threaded interface, a locating interface, a NATO interface, and a dovetail groove interface, configured for mounting external accessories. For example, accessories such as a flash unit may be mounted.

Regarding the mounting member 21, the manner in which the external expansion mount 13 is mounted on the connecting tube can be similar to the locking manner of the first cage body 222 and the second cage body 223 described above, or existing tube clamps may be employed, which will not be elaborated upon herein.

What is claimed is:

1. A handheld shooting mechanism, comprising:
a handheld assembly comprising a connecting portion and a plurality of handles respectively disposed at opposite ends of the connecting portion; and
a mounting assembly, mounted on the connecting portion, configured for mounting a drone within the mounting assembly.

2. The handheld shooting mechanism according to claim 1, further comprising a grip assembly, wherein the grip assembly is connected to a top of the mounting assembly or to the connecting portion, and the grip assembly is above the connecting portion.

3. The handheld shooting mechanism according to claim 2, wherein the grip assembly is mounted on the top of the mounting assembly;
wherein the mounting assembly is positioned below the connecting portion;
wherein the grip assembly is positioned above the connecting portion, and a center line of the grip assembly coincides with a center line of the mounting assembly;
wherein the grip assembly comprises a grip and a first fastener;
wherein one of a bottom of the grip and the top of the mounting assembly is provided with a first slider, and another one of the bottom of the grip and the top of the mounting assembly is provided with a first sliding groove; and
wherein the first slider is configured to be disposed in the first sliding groove, and the first fastener is configured to pass through the bottom of the grip and threadedly connect to the mounting assembly.

4. The handheld shooting mechanism according to claim 1, wherein the mounting assembly comprises a mounting member and a mounting cage;
wherein the mounting member is mounted on the connecting portion; and
wherein the mounting cage is configured to be mounted around an outer periphery of the drone, and the mounting cage is mounted on the mounting member.

5. The handheld shooting mechanism according to claim 4, wherein a top of the mounting cage is provided with a second slider, and a side of the second slider facing the mounting member is provided with at least one limiting recess;
wherein a bottom of the mounting member is provided with a second sliding groove and is elastically provided with a limiting member, and a side of the second sliding groove facing the second slider is provided with an opening, and the limiting member is configured to expose; and
wherein in response to the second slider being mounted in the second sliding groove, the limiting member is configured to protrude from the opening and engaging in the limiting recess.

6. The handheld shooting mechanism according to claim 5, wherein the second sliding groove and the second slider are in inclined surface engagement;
wherein the limiting member comprises a limiting shaft, an elastic member, and a button;
wherein the button is connected to the limiting shaft and protrudes out of the mounting member, and the elastic member is sleeved on the limiting shaft and disposed between the button and the mounting member;
wherein an end of the limiting shaft away from the button is provided with a limiting protrusion, and the limiting protrusion is provided with a limiting inclined surface; and
wherein the limiting recess is arranged obliquely, and when the second slider is mounted in the second sliding groove, the limiting member is configured to protrude from the opening, enabling the limiting inclined surface to abut against the limiting recess.

7. The handheld shooting mechanism according to claim 6, wherein the limiting shaft comprises a first shaft body and a second shaft body connected to each other;
wherein the first shaft body is connected to the button, and an end of the second shaft body away from the first shaft body is provided with a limiting protrusion;
wherein the mounting member comprises a first hole channel, a second hole channel, and a third hole channel;
wherein a first through hole communicates between the first hole channel and the second hole channel to form a first stopper wall;
wherein the first stopper wall is configured to limit the second shaft body; and
wherein a second through hole communicates between the second hole channel and the third hole channel to form a second stopper wall, and the second stopper wall is configured to limit the limiting protrusion.

8. The handheld shooting mechanism according to claim 4, wherein the mounting cage comprises a first cage body, a second cage body, and a first locking member;
wherein the first cage body is connected to the bottom of the mounting member, a first end of the first cage body and a first end of the second cage body are movably connected; and
wherein a second end of the first cage body and a second end of the second cage body are detachably connected via the first locking member to form a mounting space for mounting the drone.

9. The handheld shooting mechanism according to claim 8, wherein two sides of the first cage body are provided with buckle bodies bent toward a center line of the first cage body for limiting and fixing propellers of the drone.

10. The handheld shooting mechanism according to claim 8, wherein two sides of the second cage body are provided with buckle bodies bent toward a center line of the second cage body for limiting and fixing the propellers of the drone.

11. The handheld shooting mechanism according to claim 8, wherein two sides of the first cage body are provided with buckle bodies bent toward a center line of the first cage body for limiting and fixing propellers of the drone; and
wherein two sides of the second cage body are provided with buckle bodies bent toward a center line of the second cage body for limiting and fixing the propellers of the drone.

12. The handheld shooting mechanism according to claim 9, wherein a side of the second cage body facing away from the mounting space is connected with a quick release plate for mounting the handheld shooting mechanism to external photographic equipment.

13. The handheld shooting mechanism according to claim 1, wherein a first handle of the plurality of handles is mounted with a mounting base, and the mounting base is configured to mount a remote control handle of the drone; and
wherein the mounting base is detachably mounted on a bottom of the first handle via a second fastener, and the mounting base is configured to adjust an inclination angle relative to the mounting assembly.

14. The handheld shooting mechanism according to claim 1, wherein the connecting portion comprises a connecting tube, and one or more external expansion mounts are disposed on the connecting tube; and
wherein the one or more external expansion mounts comprise at least one of a cold shoe interface, a threaded interface, a positioning interface, a NATO interface, and a dovetail groove interface for mounting an external accessory.
